(19) United States
(12) Patent Application Publication
(10) Pub. No.: US 2018/0056195 A1
(43) Pub. Date: Mar. 1, 2018

(54) SCREEN BASEBALL METHOD USING A MOBILE DEVICE

(71) Applicant: Realyagu Zone Co., Ltd., Seoul (KR)

(72) Inventors: Seung Jin Lee, Seoul (KR); Han Jo Kwon, Seoul (KR); Hyoung Gon Kim, Seoul (KR)

(21) Appl. No.: 15/683,671

(22) Filed: Aug. 22, 2017

(30) Foreign Application Priority Data
Aug. 29, 2016 (KR) 10-2016-0110150

(51) Int. Cl. A63F 13/79; H04L 29/08; A63F 13/812; A63F 13/49

(52) U.S. Cl. CPC A63F 13/79; H04L 67/306; H04W 84/12; A63F 13/49; A63F 13/812

(57) ABSTRACT

Disclosed is a method for screen baseball using a mobile device. The method comprises (a) confirming whether a user of the mobile device is a member when the mobile device recognizes an identifier image shown on the display of the operator PC; (b) automatically logging in once the user is confirmed to be a member; and (c) controlling the screen baseball in real-time when the user's automatically logged-in mobile device is located in a Wi-Fi area. According to the present disclosure, the user is automatically logged in by recording and simply recognizing the Wi-Fi service set identifier image marked in the operator PC located in the screen baseball system, without installing an additional reader, thereby improving the user's convenience and simplicity as well as the operator's productivity. Additionally, by using the mobile device as a controller of the offense or defense of the screen baseball, the user can change a game plan, etc. in real-time without pause, thereby effectively inducing the user's participation and interest.

### BACKGROUND

### Technical Field

The present disclosure relates to a screen baseball method using a mobile device, in particular, to a screen baseball method using a mobile device comprising automatically logging in by recognizing a pre-determined identifier provided by a display of an operator PC without an additional reader and using the mobile device as a controller which enables real-time control of offense or defense of the screen baseball without pause.

### Description of the Related Art

Along with the recent development of mobile devices, various contents or mobile games have emerged as new items that can create profits in the mobile market.

Meanwhile, it is currently difficult for small mobile game companies to advertise mobile games that they have developed.

Meanwhile, in Japan, net cafes having a mixed concept of PC rooms and cafe are being revitalized, and the number of such net cafes in Korea is gradually increasing as well.

In such case, if mobile game items are sold offline at the net cafes or there is a privilege for mobile games connected via an access point of an operator installed in the net cafes, sales of the net cafes will increase, and the mobile game companies and system businesses that established the access points (APs) may also profit.

Due to such necessity, a mobile game application system using Wi-Fi, etc., which can provide various benefits corresponding to the voucher when playing the mobile game by connecting a user's mobile device to the AP established by the business and using a software development kit (SDK) included in an application (App) provided accordingly to authenticate a possessed voucher, is commercially available.

However, in a case of a conventional mobile game application system using Wi-Fi, as an authentication code image saved in the mobile device must be read by the operator PC to log in, there is a limitation in that an additional reader is required for the operator PC to recognize the authentication code.

Additionally, conventional mobile devices and operator PCs had a problem of inability to support bidirectional communications.

Meanwhile, the mobile device is not frequently used for communication although it is carried at all times, various additional functions have been added to the mobile device for effective use during the remaining time when the mobile device is not used for communication. Among the additional features, near field communication (NFC)-based wireless communication technology, a communication protocol connecting the mobile device and a reader or another mobile device to transmit a data signal at a short distance of within about 10 cm of each other, has been developed and applied.

As a wireless communication method at a short distance of 10 cm, the NFC is operated in a card mode in which electronic transactions are made such as credit cards, a P2P mode in which devices are connected on a one-to-one basis to transmit data signals, a read mode in which simple information is read and confirmed, etc., having a characteristic of low power consumption.

There have been conventional methods of automatically connecting to a wireless network at an AP simply by tagging the mobile device to an operator PC located in the AP region using such NFC or QR code, barcode, etc., to automatically log in. However, this has a limitation in that an additional reader for authentication code recognition is required and a problem in that neither the mobile device nor the operator PC supports the bidirectional communication.

In this regard, the present inventors have overcome a limitation of the conventional technology which requires an additional reader to recognize the authentication code by the operator PC, and have devised a screen baseball method for which a mobile device can function as a controller via bidirectional communication with the operator PC. KR 10-1604927 may be related art.

### BRIEF SUMMARY

### Technical Problem

An object of at least one embodiment of the present disclosure is to provide a screen baseball method using a mobile device, comprising automatically logging in by recognizing a Wi-Fi service set identifier provided by a display of an operator PC located in the screen baseball system without an additional reader and using the mobile device as a controller which controls offense or defense of the screen baseball.

### Technical Solution

The screen baseball method using the mobile device of the present disclosure comprises (a) confirming whether a user of the mobile device is a member when the mobile device recognizes an identifier image shown on the display of the operator PC; (b) the mobile device automatically logging in once the user is confirmed to be a member; and (c) controlling the screen baseball in real-time when the user's automatically logged-in mobile device is located in the Wi-Fi area.

The screen baseball method using the mobile device of the present disclosure further comprises registering as a member through installing the application using the mobile device; and displaying a Wi-Fi service set identifier image, the identifier image, on the display of the operator PC, before step (a).

Step (a) of the screen baseball method using the mobile device of the present disclosure confirms whether the user of the mobile device is a member through the Wi-Fi service set identifier.

Step (b) of the screen baseball method using the mobile device of the present disclosure further comprises sending user information to the operator PC by the mobile device.

Step (c) of the screen baseball method using the mobile device of the present disclosure comprises (c-1) confirming whether the automatically logged-in mobile device goes out of the Wi-Fi area in real-time; (c-2) automatically logging out if the automatically logged-in mobile device is out of the Wi-Fi area; (c-3) confirming whether the automatically logged-out mobile device out of the Wi-Fi area is again located in the Wi-Fi area; and (c-4) proceeding with the screen baseball control in a case when it is confirmed that the mobile device is not out of the Wi-Fi area.

The mobile device automatically logs in again in step (c-3) of the screen baseball method using the mobile device of the present disclosure if it is confirmed that the automatically logged-out mobile device is again located in the Wi-Fi area.

The screen baseball method using the mobile device of the present disclosure repeatedly checks whether the automatically logged-out mobile device is located in the Wi-Fi area again in real-time if the automatically logged-out mobile device is not located in the Wi-Fi area again.

Step (c) of the screen baseball method using the mobile device of the present disclosure controls an offense game by selecting at least one of buster, pinch runner, base stealing, hit and run, run and hit, and bunt in the offense mode using the mobile device.

Step (c) of the screen baseball method using the mobile device of the present disclosure enables the control of batting order or plays a pinch hitter based on hitter ability data pre-saved in the DB server in the offense mode using the mobile device.

Step (c) of the screen baseball method using the mobile device of the present disclosure controls a defense game by selecting at least one of defense shift, pitcher's pitch, change of ball, velocity, command, and intentional base on balls in the defense mode using the mobile device.

Step (c) of the screen baseball method using the mobile device of the present disclosure replaces a starting pitcher or a closing pitcher, or changing a starting rotation order in the defense mode using the mobile device.

The screen baseball method using the mobile device of the present disclosure further comprises confirming continuation of the screen baseball play of the user by the operator PC; and returning to step (c-1) when the user is willing to keep playing, after step (c-4).

The screen baseball method using the mobile device of the present disclosure ends the play when the user is confirmed to be a non-member in step (a) or the user is not willing to keep playing after step (c).

Specific descriptions of other Examples are included in Best Mode and Drawings.

Advantages and/or technical features of the present disclosure as well as methods of obtaining the same will be clearer with reference to the accompanying embodiments.

However, the present disclosure may be embodied in many different forms and should not be construed as being limited to the example embodiments set forth herein. Rather, these example embodiments are provided so that this disclosure will be thorough and complete, and will fully convey the scope of the present disclosure to those skilled in the art.

### Advantageous Effect

According to the present disclosure, the user is automatically logged in by recording and simply recognizing the Wi-Fi service set identifier image marked in the operator PC located in the screen baseball system through the mobile device, without installing an additional reader, thereby improving the user's convenience and simplicity as well as the operator's productivity.

Additionally, by using the mobile device as a controller of the offense or defense of the screen baseball, the user can change a game plan, etc. in real-time without pause, thereby effectively inducing the user's participation and interest.

### BRIEF DESCRIPTION OF THE SEVERAL VIEWS OF THE DRAWINGS

FIG. 1 is a schematic diagram for implementation of the screen baseball using the mobile device according to the present disclosure.

FIG. 2 is a flow chart which schematically shows the operation of the screen baseball using the mobile device according to an exemplary embodiment of the present disclosure.

FIG. 3 is a flow chart which shows the detailed operations of S200 among the operations of the screen baseball method shown in FIG. 2.

FIG. 4 is a flow chart which shows the detailed operations of S400 among the operations of the screen baseball method shown in FIG. 2.

### DETAILED DESCRIPTION

Hereinafter, with reference to the drawings, preferred embodiments of the present disclosure will be described in detail.

Before describing the present disclosure in depth, it should be understood that the terminology or vocabulary used in the present disclosure should not be interpreted as being limited to typical meanings or dictionary definitions, and the present inventors may suitably define the concepts of terminology to describe their disclosure in the best way possible. Furthermore, the terminology or vocabulary in the present disclosure should be interpreted in terms of meanings and concepts that conform to the technical subject matter of the present disclosure.

In other words, the terminology used herein is used to merely describe the preferred embodiments of the present disclosure, but is not intended to be limiting. The terminology should be understood as the terminology defined in consideration of various possibilities.

Additionally, when used in this specification, the singular forms may include the plural forms as well unless the context clearly indicates otherwise. It should also be understood that similar plural forms may include the singular forms.

Throughout the entire specification, the terms “comprise,” “include,” etc., may mean that one or more other components, steps, operations, and/or the existence or addition of elements are not excluded in addition to the described components, steps, operations, and/or elements unless context indicates otherwise.

Further, it should be understood that if a certain element is described as being “disposed in” or “connected to” another element, the certain element may be directly coupled with, in contact with, or spaced at a predetermined distance from the other element. When the elements are spaced at a predetermined distance from each other, a description of a third element for fastening or connecting the elements to each other can be omitted.

In contrast, it should be understood that when an element is referred to as being “directly coupled” or “directly connected” to another element, there are no intervening third elements present.

Other expressions that explain the relationship between elements, such as “between,” “directly between,” “adjacent to,” or “directly adjacent to,” should also be construed in the same way.

Additionally, if terms such as “a face,” “the other face,” “a side,” “the other side,” “the first,” “the second,” etc. are used in this specification, it should be understood that the terms are used to clearly distinguish an element from other elements. Further, it should also be understood that the terms are not intended to limit the meaning of corresponding elements.

If terms related to positions such as “top,” “bottom,” “left,” “right,” etc. are used in this specification, it should be understood that the terms represent a relative position of a corresponding element of a corresponding drawing and do not indicate an absolute position unless context indicates otherwise.

Besides, if terms such as “unit,” “device,” “module,” “apparatus,” etc. are used in this specification, it should be understood that the terms mean a unit which can perform one or more functions or operations and the unit can be implemented as hardware, software, or a combination thereof.

Additionally, in this specification, the same elements are intended to have the same reference numerals even though the elements are shown in different drawings. In other words, the same reference numerals indicate the same element throughout the specification.

A size, location, combination, etc. of each element in Drawings of this specification may be somewhat exaggerated, oversimplified, or omitted to fully and clearly convey the spirit and scope of the disclosure or to simplify the description of the present disclosure, and thus, scales and proportions may not be precisely measured.

Additionally, when it is determined that detailed descriptions for elements, e.g., well-known technology including conventional technology, unnecessarily make the point of the present disclosure unclear, the detailed descriptions can be omitted.

The mobile device described hereinafter includes a smart phone, personal digital assistant (PDA), portable multimedia player (PMP), smart pad, etc. capable of supporting a computer such as an internet network.

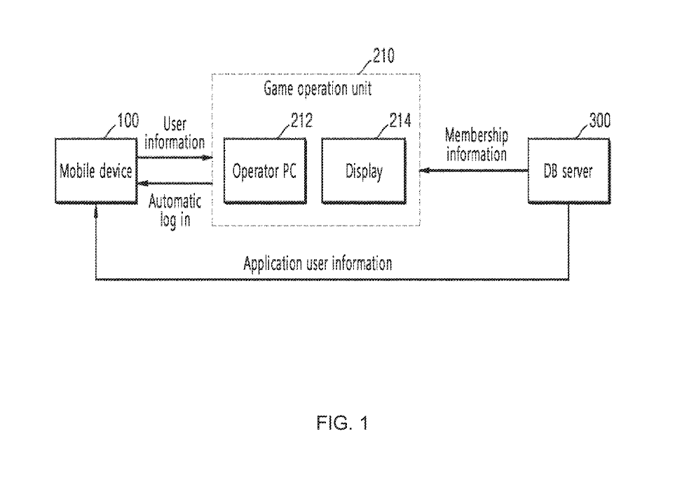

FIG. 1 is a schematic diagram for implementation of the screen baseball using the mobile device according to the present disclosure and includes a mobile device (100), a game operation unit (210), and a DB server (300), wherein the game operation unit (210) includes an operator PC (212) and a display (214).

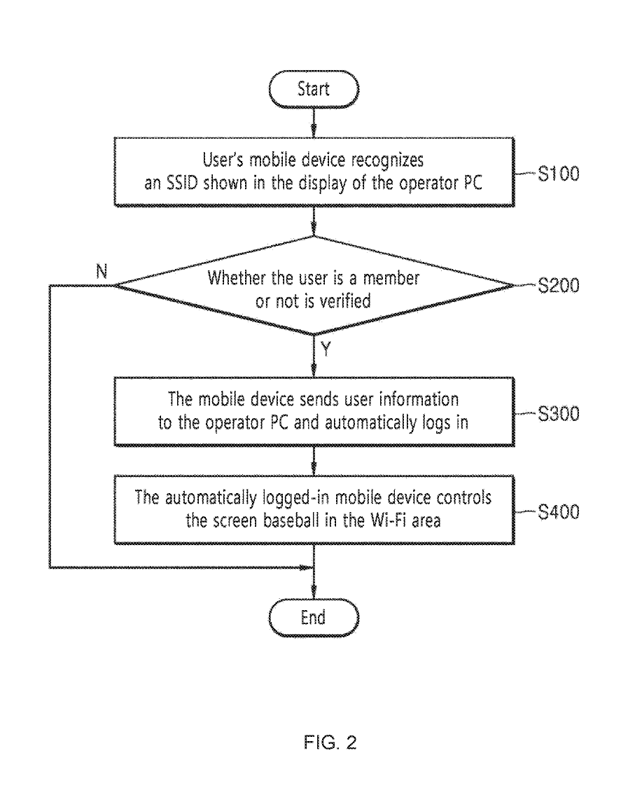

The description of general functions of each element of the screen control device according to an exemplary embodiment of the present disclosure with reference to FIGS. 1 and 2 is as follows. The systematic operations between elements will be described in detail hereinbelow.

The mobile device (100) registers a user as a member through a pre-determined membership registration process once the screen baseball application is downloaded. Once the membership is confirmed in the operator PC (212), the mobile device (100) automatically logs in in a Wi-Fi area and controls offense and defense of the screen baseball in real-time, and automatically logs out when the mobile device (100) goes out of the Wi-Fi area.

The operator PC (212) automatically logs in the mobile device (100) which records a Wi-Fi service set identifier image using the built-in camera function in the Wi-Fi area when the identifier image, i.e., Wi-Fi Service Set Identifier (SSID) image is displayed in the display (214).

The DB server (300) provides pre-saved membership information and pre-saved data for hitter ability and pitchers to the operator PC (212) and to the mobile device (100), respectively.

The mobile device (100) and the operator PC (212) are connected via a wireless network, enabling the information and data transfer via bidirectional communication.

FIG. 2 is a flow chart which schematically shows the operation of the screen baseball using the mobile device according to an exemplary embodiment of the present disclosure.

The description of the schematic operations of the screen baseball using the mobile device according to an exemplary embodiment of the present disclosure with reference to FIGS. 1 and 2 is as follows.

The mobile device (100) records and recognizes the Wi-Fi service set identifier image displayed in the display (214) of the operator PC (212) using the built-in camera function once the application of the present disclosure runs (S100).

Whether the user of the mobile device (100) is a member is determined according to whether the application of the present disclosure is installed on the mobile device (100) (S200).

If the user is confirmed to be a member, the mobile device (100) sends the information of the user of the mobile device (100) which recorded the Wi-Fi service set identifier image shown in the display of the operator PC (212), and automatically logs in (S300). If the user is confirmed to be a non-member, the operation ends.

During the automatic log-in process, the operator PC (212) reads the membership information pre-saved in the DB server (300).

When the automatically logged-in mobile device (100) is located in the Wi-Fi area, the mobile device (100), as a controller, controls the screen baseball (S400).

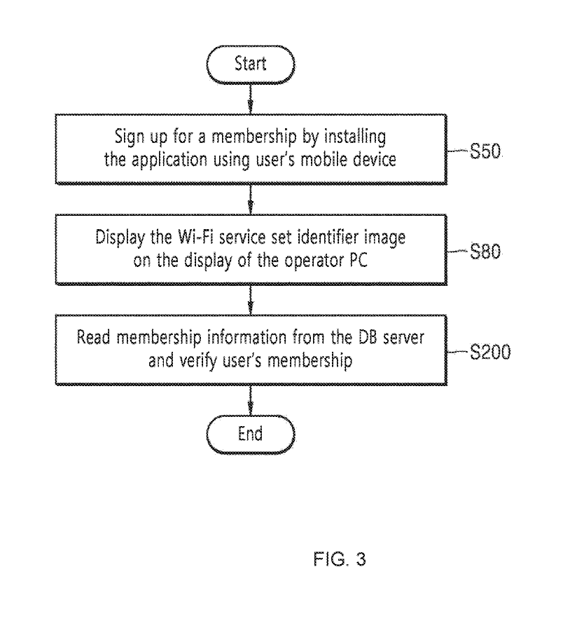

FIG. 3 is a flow chart which shows the detailed operations of S200 among the operations of the screen baseball method.

Among the operations of the screen baseball method shown in FIG. 2, S200 is briefly described hereinbelow with reference to FIGS. 1 and 3.

The user installs the application of the present disclosure through the mobile device (100) to become a member (S50).

The Wi-Fi service set identifier image is displayed in the display (214) of the operator PC (212) (S80).

The membership of the user is confirmed according to whether the application of the present disclosure is installed on the mobile device (100) (S200).

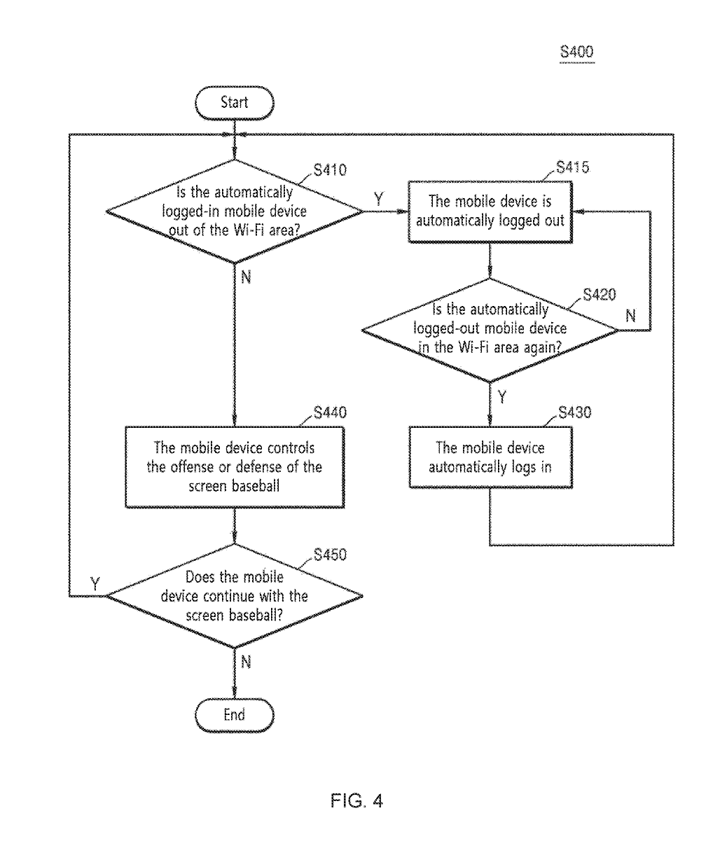

FIG. 4 is a flow chart which shows the detailed operations of S400 among the operations of the screen baseball method shown in FIG. 2.

Among the operations of the screen baseball method shown in FIG. 2, S400 is briefly described hereinbelow with reference to FIGS. 1 and 4.

First, it is assumed that an AP is installed on or nearby the operator PC (212).

The automatically logged-in mobile device (100) frequently confirms if the mobile device (100) is out of the Wi-Fi area (S410).

If the automatically logged-in mobile device (100) goes out of the Wi-Fi area, the mobile device (100) automatically logs out (S415).

Whether the automatically logged-out mobile device (100) is again located in the Wi-Fi area is frequently confirmed (S420).

When the automatically logged-out mobile device (100) is again located in the Wi-Fi area, the mobile device (100) returns to S410 after the automatic log-in.

If the automatically logged-out mobile device (100) is not confirmed to be located in the Wi-Fi area again, the mobile device (100) repeats the operation of confirming of re-entry into the Wi-Fi area (S420) until the mobile device (100) does so.

When the mobile device (100) is confirmed to be in the Wi-Fi area during S410, the mobile device (100) controls the offense or defense of the screen baseball as a controller (S440).

After the user plays the screen baseball through the mobile device (100), the operator PC (212) confirms whether the mobile device (100) continues the screen baseball play (S450).

When the mobile device (100) is confirmed to be continuing the screen baseball play, the operator PC (212) returns to S410. Otherwise, the operation ends.

The description of the detailed operations of the screen baseball using the mobile device according to an exemplary embodiment of the present disclosure with reference to FIGS. 1 to 4 is as follows.

First, it is assumed that the user is a registered member by installing the application of the present disclosure on the mobile device (100) (S50), and the Wi-Fi service set identifier image is displayed on the display (214) of the operator PC (212) (S80).

When the user runs the application of the present disclosure and uses the mobile device (100) as a camera to record and recognize the Wi-Fi service set identifier image shown on the display (214) of the operator PC (212) (S100), the user of the mobile device on which the application of the present disclosure is installed is recognized as a registered member (S200).

The Wi-Fi service set identifier image refers to a unique identifier that exists in the header of all packets transferred through wireless LAN (WLAN) and is used to distinguish a WLAN from other WLANs when a WLAN client establishes a connection to a Base Service Set (BSS), a very basic network building block of an IEEE 802.11.

Unique information granted to the Wi-Fi service set identifier image includes an IP address, etc., of the screen baseball device.

If the user recognized by recording the Wi-Fi service set identifier image shown in the display (214) of the operator PC (212) using the mobile device (100) is confirmed to be a registered member, the mobile device (100) transfers the user information to the operator PC (212) and automatically logs in (S300).

When the user is not confirmed to be a member in S200, the log-in process fails and the operation ends.

Once the automatically logged-in mobile device (100) enters the Wi-Fi area, whether it goes out of the Wi-Fi area is frequently confirmed (S410).

When it is not out of the Wi-Fi area, the actual game starts and the mobile device (100) controls the offense or defense of the screen baseball in various ways as a controller without pause (S440).

When the automatically logged-in mobile device (100) goes out of the Wi-Fi area for some reason, for example, when the user temporarily moves while possessing the mobile device (100), the automatically logged-in mobile device (100) automatically logs out (S415).

Whether the automatically logged-out mobile device (100) is again located in the Wi-Fi area is confirmed in real-time (S420).

When the mobile device (100) is confirmed to be in the Wi-Fi area again, the mobile device (100) automatically logs in again and returns to S410.

If the mobile device (100) is not confirmed to be located in the Wi-Fi area again, S420 is repeated until it is confirmed that the mobile device (100) is again in the Wi-Fi area.

The control function of the mobile device (100) for offense or defense of the screen baseball as a controller in S450 is as follows.

For example, in the offense mode, the offense game can be controlled by selecting buster (an offensive technique wherein the hitter suddenly changes a batting posture from bunting to hitting), pinch runner, base stealing, hit and run, run and hit, bunt (sacrifice bunt, sudden bunt, squeeze bunt), etc., using the mobile device (100), without being revealed to the defense team.

Additionally, batting order of hitters can be controlled, and a pinch hitter can be played based on hitter ability data (e.g., batting eye, reaction time, hitting power, and contact ability) pre-saved in the DB server (300).

In the defense mode, the defense game can be controlled by selecting defense shift (forward or rearward arrangement of defensive players depending on the base situation of the offense team), pitcher's pitch, change of ball, velocity, command, international base on balls, etc., using the mobile device (100), without being revealed to the offense team.

Additionally, a starting pitcher or a closing pitcher can be replaced, or a starting rotation order can be changed.

After the user plays the screen baseball using the mobile device (100) in the manner described above, the operator PC (212) confirms whether the screen baseball is to be continued (S450).

If the user select an end button from the menu of the game being run on the mobile device (100) or there is no input by the user on the mobile device (100) for a pre-determined amount of time, the operator PC (212) acknowledges that the user is not willing to keep playing the screen baseball and terminates the operation of the screen baseball.

Otherwise, the operator PC (212) confirms that the user is willing to continue the screen baseball and returns to step S410.

As described above, the screen baseball method using a mobile device of the present disclosure uses the mobile device to automatically log in by recognizing a Wi-Fi service set identifier provided by a display of an operator PC located in the screen baseball system without an additional reader and uses the mobile device as a controller which controls offense or defense of the screen baseball.

Accordingly, the present disclosure enables the user to automatically log in by recording and simply recognizing the Wi-Fi service set identifier image marked in the operator PC located in the screen baseball system, without installing an additional reader, thereby improving the user's convenience and simplicity as well as the operator's productivity.

Additionally, by using the mobile device as a controller of the offense or defense of the screen baseball, the user can change a game plan, etc. in real-time without pause, thereby effectively inducing the user's participation and interest.

Although several exemplary embodiments of the present disclosure have been described with some examples, the description of the various exemplary embodiments in Best Mode is for illustrative purpose only. Those skilled in the art will appreciate that various modifications or equivalents thereof can be performed based on the above descriptions.

Additionally, the present disclosure is not limited to the descriptions above, as it may be embodied in different ways. The above descriptions are provided to render the present disclosure complete and the scope of the present disclosure comprehensible to those skilled in the art. It should be understood that the present disclosure is only to be defined by the claims.

### REFERENCE NUMERALS

100: Mobile device
210: Game operation unit
212: Operator PC
214: Display
300: DB server

1. A method for screen baseball using a display of an operator PC located in a screen baseball system in which a Wi-Fi area is set; and a mobile device carried by a user of the screen baseball system, the method comprising:
(a) confirming whether a user of the mobile device is a member when the mobile device recognizes an identifier image shown on the display of the operator PC;
(b) the mobile device automatically logging in once the user is confirmed to be a member; and
(c) playing the screen baseball and controlling the screen baseball in real-time using the mobile device when the user's automatically logged-in mobile device is located in the Wi-Fi area,
wherein the mobile device automatically logs out when the mobile device goes out of the Wi-Fi area, disabling the control of the screen baseball through the mobile device, and the mobile device automatically logs in when it is again located in the Wi-Fi area, enabling the control of the screen baseball during step (c),
wherein the control of the screen baseball comprises control for an offense mode and control for a defense mode in the screen baseball system.

2. The method of claim 1, wherein the method further comprises registering as a member through installing an application using the mobile device; and displaying a Wi-Fi service set identifier image, the identifier image, on the display of the operator PC, before step (a).

3. The method of claim 2, wherein step (a) confirms whether the user of the mobile device is a member through the Wi-Fi service set identifier.

4. The method of claim 2, wherein step (b) further comprises sending user information to the operator PC by the mobile device.

5. The method of claim 1, wherein step (c) comprises:
(c-1) confirming whether the automatically logged-in mobile device goes out of the Wi-Fi area in real-time;
(c-2) automatically logging out if the automatically logged-in mobile device is out of the Wi-Fi area;
(c-3) confirming whether the automatically logged-out mobile device out of the Wi-Fi area is again located in the Wi-Fi area; and
(c-4) proceeding with the screen baseball control in a case when it is confirmed that the mobile device is not out of the Wi-Fi area.

6. The method of claim 5, wherein in step (c-3), if it is confirmed that the automatically logged-out mobile device is again in the Wi-Fi area, the mobile device automatically logs in again.

7. The method of claim 6, wherein checking whether the automatically logged-out mobile device is located in the Wi-Fi area again is repeated in real-time if the automatically logged-out mobile device is not located in the Wi-Fi area again.

8. The method of claim 1, wherein step (c) controls an offense game by selecting at least one of buster, pinch runner, base stealing, hit and run, run and hit, and bunt in the offense mode using the mobile device.

9. The method of claim 2, wherein step (c) enables the control of batting order or plays a pinch hitter based on hitter ability data pre-saved in a DB server in the offense mode using the mobile device.

10. The method of claim 1, wherein step (c) controls a defense game by selecting at least one of defense shift, pitcher's pitch, change of ball, velocity, command, and intentional base on balls in the defense mode using the mobile device.

11. The method of claim 1, wherein step (c) replaces a starting pitcher or a closing pitcher, or changing a starting rotation order in the defense mode using the mobile device.

12. The method of claim 5, wherein the method, after step (c-4), further comprises confirming continuation of the screen baseball play of the user by the operator PC; and returning to step (c-1) when the user is willing to keep playing.

13. The method of claim 12, wherein the operation ends when the user is confirmed to be a non-member in step (a) or the user is not willing to keep playing after step (c).
